(19) United States
(12) Patent Application Publication
(10) Pub. No.: US 2016/0140131 A1
(43) Pub. Date: May 19, 2016

(54) METHOD AND SYSTEM FOR DATA TRANSFORMATION FOR CLOUD-BASED ARCHIVING AND BACKUP

(71) Applicant: ProphetStor Data Services, Inc., Taichung (TW)

(72) Inventors: Wen Shyen CHEN, Taichung (TW); Sheng Lin WU, Taichung (TW)

(73) Assignee: ProphetStor Data Services, Inc., Taichung (TW)

(21) Appl. No.: 14/547,305

(22) Filed: Nov. 19, 2014

(51) Int. Cl. G06F 17/30

(52) U.S. Cl. CPC G06F 17/30073; G06F 17/30082

(57) ABSTRACT

A system and a method for data transformation for cloud-based archiving and backup are disclosed. The system includes an original disk storage, an object storage and a Data Transformation and Virtualization Module (DTVM). The DTVM can transform an original data in the original disk storage into an archiving data which has objects, pointers, and a metadata including an environmental information, and store the archiving data to the object storage by a storing means. Thus, in addition to restoring of the archiving data which is available, with the drivers for booting added to objects, pointers, and a metadata, recovery of the original disk storage with booting function can be available.

### FIELD OF THE INVENTION

The present invention relates to a method and a system for data transformation for cloud-based service. More particularly, the present invention relates to a method and a system for data transformation for cloud-based archiving and backup.

### BACKGROUND OF THE INVENTION

Conventionally, enterprises process data archiving and data backup for different purposes. For example, archiving the accounting data as auditing trail for several years is mandatory as required by the Government regulation, while data backup is used in all kinds of data in case of the breakdown of the operating host which results in the data lost and the urgent need for the lost data always happens. Systems for each purpose usually need to store a considerable amount of data from a local storage to any other types of media locally or remotely. However, besides the purpose, differences between the two systems reside also in the storing format, the restoring urgency, and recovery complexity. Usually the IT staffs in the enterprise have to implement both systems.

In detail, there are two stages for both systems: storing and restoring stages for archiving system, and backup and recovery stages for backup system. When in storing stage of archiving system, block content in the local storage is transformed into an archiving format in a form of files, databases, records or objects and delivered to other local or remote media to be long-term stored. The local or remote media may be a tape, Digital Video Disk (DVD), and Hard Disk Drive (HDD). It can even be cloud storage for the remote media. A number of archiving formats can be applied. For example, Digital Imaging and Communications in Medicine (DICOM) format, TAR format, GZIP format, etc. As to a backup system, data for backup may be snapshotted and uploaded to the local or remote media. Data format is not limited but usually resembles that of the original data. When the archiving system works at a restoring stage, the stored archived data are restored and recovered to the original format and been accessed by the original or similar host system in order to achieve the target of recovery. If the storing stage in archiving is processed based on files, it is necessary to prepare the same operating system and operation environment before the restoring stage initiates. For the recovery stage in backup system, the recovery requires not only the lost data, but a way to come back to the time the data lost and the system continue to operate and provide the service as smooth as possible.

When data in a storage is backed up, it is done based on files or blocks, online replicating to a remote storage from a local storage. The backup format used in the remote storage should be the same as that of the local storage. There is usually one storage management server for the remote storage, the same as or similar to the one used for the local storage, always online to receive backup data. If recovery of backed up data is required, the storage management server can function immediately. Such system needs great bandwidth, especially for the first initial synchronization. Besides, an extra storage management server is required to stand by online that introduces a very high cost. It doesn't meet the cost structure required by Cloud Computing on-demand Resource.

In order to settle the problem mentioned above, there are some prior arts which can be applied. For example, the US Patent Publication No. 2011/0282844 may be a solution. A client-server multimedia archiving system with metadata encapsulation is disclosed in the application. Although it is described to be used for multimedia, generic data can be applied. The system employs a server and a library coupled to the server. The server is for receiving information to be archived from one of the clients. The server has an information logical partition for holding the received information. When receiving the information, the server encapsulates the information with metadata associated with the information and stores the encapsulated information in the library. The metadata can include any data regarding to the encapsulated information, such as category, purpose of use, users, etc. Since the information stored is classified, when restoring is required, it is much easier to find out which one among a huge amount of data should be restored. Meanwhile, because target information can be found and sent back to a host in a short time, extra storage management server is not necessary for controlling restoring processes and fulfilling on-demand instant recovery but recovery time objective can be obtained. As to archiving, it is usually not rush and data of the information can be sequentially received by the library, even the archived information is burned into a DVD and the DVD is used as a media for storing the archived information to the library.

However, there are still issues. If the environment of operating system in the client is changed, recovery may not be available after restoring. The metadata encapsulated doesn't benefit to different environments of recovery. Also, it does not take advantage of the cloud-based architecture for data restoring and recovery, especially when the system comes with low-cost object-based cloud storage (no storage management server is needed).

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

According to an aspect of the present invention, a method for data transformation for cloud-based archiving and backup, includes the steps of: A. receiving an original data from an original disk storage; B. transforming the original data into an archiving data having objects, pointers, and a metadata comprising an environmental information, wherein each object is referred to by a pointer; and C. storing the archiving data to an object storage by a storing means.

Preferably, the environmental information includes working environment of the original disk storage, system booting of a host by which the original disk storage is accessed, and hardware configuration of the host. The object is a disk block data or a file. The archiving data can be in its original form or de-duplicated, compressed, or encrypted before step C. Relationship between objects is stored in the pointer and the metadata. The storing means stores the archiving data integrally or by groups of objects. Furthermore, the storing means is uploading via internet, uploading via Local Area Network (LAN), uploading via Wild Area Network (WAN), or exporting to a Digital Video Disk (DVD), dispatching the DVD to where the object storage is, and importing the content of the DVD to the object storage.

The method for recovering the archiving data comprises the steps of: D. receiving the archiving data from the object storage; E. searching for an initiating information of the original disk storage that is not included in the environmental information after step A or an initiating information of a target disk storage that is not included in the environmental information; F. adding that initiating information into the metadata, the pointer, or the object; and G. restoring and recovering the archiving data to the original disk storage or the target disk storage.

According to another aspect of the present invention, a system for data transformation for cloud-based archiving and backup includes: an original disk storage for storing data; an object storage for storing data in form of an object with an associated metadata and a unique identifier; a Data Transformation and Virtualization Module (DTVM), for receiving an original data from an original disk storage, transforming the original data into an archiving data having objects, pointers, and a metadata including an environmental information, and storing the archiving data to the object storage by a storing means. Each object is referred to by a pointer.

The DTVM can further receive the archiving data from the object storage, search for an initiating information of the original disk storage that is not included in the environmental information after the original data has been sent from the original disk storage or an initiating information of a target disk storage that is not included in the environmental information, add that initiating information into the metadata, the pointer, or the object, and restore the archiving data to the original disk storage or the target disk storage. The target disk storage stores data. The DTVM optionally restores the archiving data to the target disk storage.

Preferably, the DTVM is a standalone server, or a software installed in the original disk storage or an application server linked to the original disk storage.

The present invention takes advantages of the cloud-based storage and architecture, resolving the backup/recovery issues of the backup system from archiving schemes, and thus providing the unified method to achieve both archiving and backup with cost reduction and flexibility.

### BRIEF DESCRIPTION OF THE DRAWINGS

FIG. 1 is a schematic diagram of a system for data transformation for cloud-based archiving and backup according to the present invention.

FIG. 2 illustrates a data structure of an archiving data.

FIG. 3 is a flow chart of a method for operating the system at archiving stage according to the present invention.

FIG. 4 is a flow chart of a method for operating the system at restoring stage according to the present invention.

FIG. 5 is another schematic diagram of a system for data transformation for cloud-based archiving and backup according to the present invention.

FIG. 6 is still another schematic diagram of a system for data transformation for cloud-based archiving and backup according to the present invention.

### DETAILED DESCRIPTION OF THE PREFERRED EMBODIMENTS

The present invention will now be described more specifically with reference to the following embodiments.

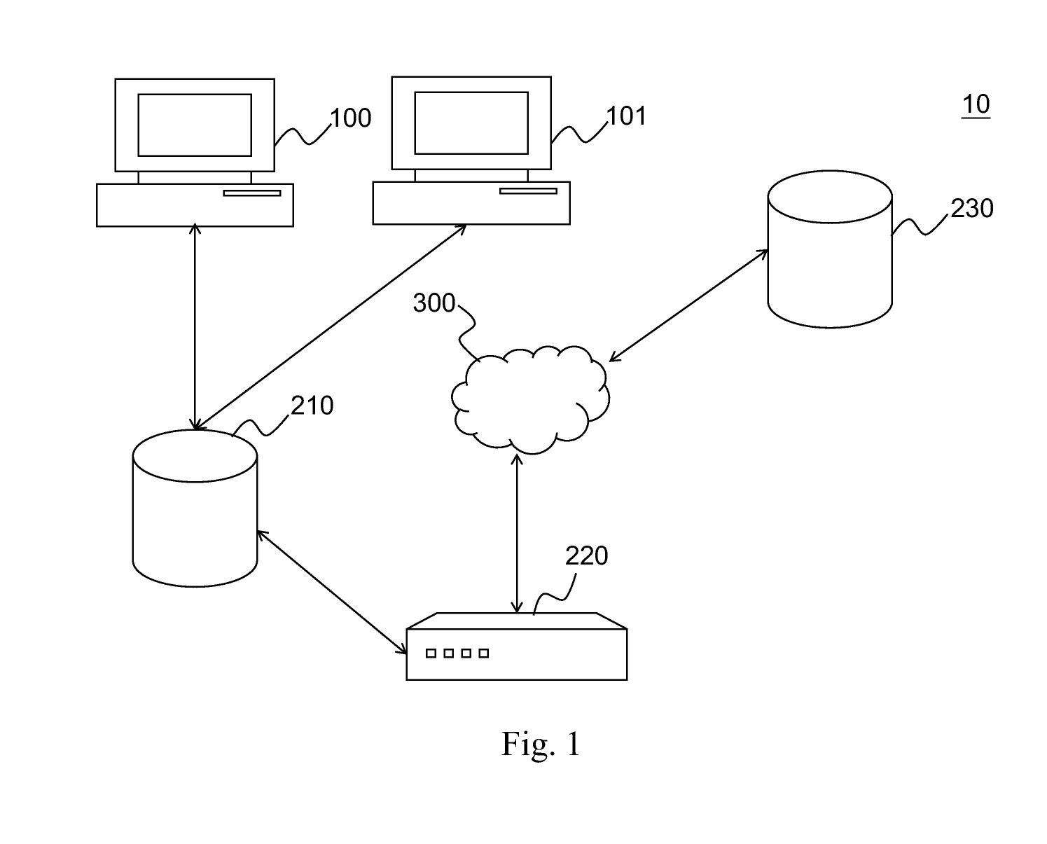

Please refer to FIG. 1. An embodiment of a system 10 for data transformation for cloud-based archiving and backup according to the present invention is disclosed. The system 10 includes an original disk storage 210, an object storage 230, and a Data Transformation and Virtualization Module (DTVM) 220. In fact, the system 10 can have a number of original disk storages 210, object storages 230, and/or a DTVMs 220 so that data archiving or backup is able to perform wherever one object storage 230 is available for requests from any original disk storages 210. It is understandable that there are some devices or functions between the original disk storage 210 and the DTVM 220 or between the object storage 230 and the DTVM 220 are omitted for illustration purpose. These devices or functions may be a server working for managing data for archiving or backup, or the way of data interfacing. The difference between archiving and backup depends on the time the data is stored and the purpose the data are restored. Operation mechanism for archiving or backup in the system 10 is the same. The spirit of the present invention is to define a method to transform and restore archiving data, while the method can accomplish the task of the backup and recovery of the backup system.

The original disk storage 210 is used for storing data. Typically, the original disk storage 210 is used in Storage Area Network (SAN) environments where data is stored in volumes, also referred to as blocks. The original disk storage 210 may be linked to a host (application server) 100. The host 100 accesses the original disk storage 210 so that necessary data, such as streaming films for a streaming server, can be provided.

The object storage 230 is for storing data in form of objects. Each object comes with an associated metadata and a unique identifier. According to the definition of a generic object storage, the metadata is the data for the stored data. For example, the metadata is defined by whoever creates the objects and contains contextual information about what the data is, what it should be used for, its confidentiality, or anything else that is relevant to the way in which the data is used. However, according to the present invention, contents of the metadata are not so limited. It will be described in details later. Since the system 10 is a cloud-based structure, data transfer goes through internet 300. Internet 300 can be replaced by Local Area Network (LAN) or Wild Area Network (WAN), as long as the structure fulfills remote archiving or backup.

The DTVM 220 is the key part in the present invention. At archiving stage of the original disk storage 210, the DTVM 220 can receive an original data from an original disk storage 210, transform the original data into an archiving data which has objects, pointers, and a metadata, and store the archiving data to the object storage 230 by a storing means. The original data may contain a number of files, be a database, or just be a snapshot of the original disk storage 210. The archiving data has different format from that of the original data. In addition to the contents mentioned above, the metadata created from the DTVM 220 includes an environmental information. The environmental information comprises, but is not limited to, working environment of the original disk storage 210, system booting of the host 100 by which the original block storage 210 is accessed, and hardware configuration of the host 100. Working environment refers to any setup of software or operating system when the original data is in the original disk storage 210.

The storing means is to upload the archiving data for storing via internet 300. If the internet 300 is replaced by LAN or WAN applied in this embodiment, the storing means is uploading via LAN or uploading via WAN, respectively. The storing means can be used to store (or upload in this embodiment) the archiving data integrally. It can also separate the objects into several groups and store the groups in parallel to reduce the transmission time.

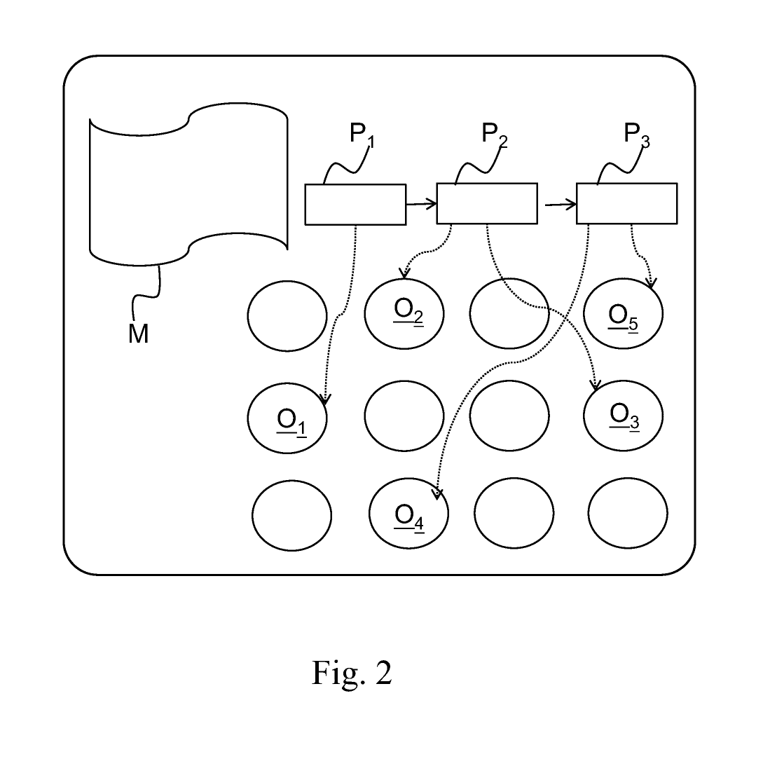

Data structure of the transferred archiving data is shown in FIG. 2. The archiving data contains a metadata M, pointers P₁, P₂, and P₃, and objects. The pointers P₁, P₂, and P₃ are linked to at least one object, respectively (Pointer P₁ links to the object O₁, Pointer P₂ links to the object O₂ and O₃, and Pointer P₃ links to the object O₄ and O₅.). The object may be a disk block data, a file, or other composing forms of the data.

If the archiving data in the object storage 230 would like to be restored back to the original disk storage 210 for recovery, namely at a restoring stage, the DTVM 220 can function to receive the archiving data from the object storage 230, search for an initiating information of the original disk storage that is not included in the environmental information after the original data has been sent from the original disk storage 210, add the initiating information into the metadata, pointers, or objects, and finally restore the archiving data to the original disk storage 210. It is obvious that the content of the initiating information may cover working environment of the original disk storage 210, system booting of the host 100 by which the original disk storage 210 is accessed, and hardware configuration of the host 100 that the environmental information doesn't include.

For example, if the operating system for the original disk storage 210 changed during the archiving data is stored in the object storage 230, an updated module of the new operating system for booting is found by the DTVM 220 and can be packed as a new object. The new object is linked to one pointer showing the location in the original disk storage 210 when the archiving data is restored. Accordingly, the metadata will be modified to include related information of the updated module. The way the system 10 processes is very convenient to operate instant recovery since only a portion of necessary objects are required to be restored back first with the new object for booting. Followed by the necessary objects are the rest objects of the archiving data. For this portion, the rest objects can be delivered to the DTVM 220 for complete recovery after the operating system is booted or some key functions work. Then, files or blocks can be assigned to the host 100.

It is obvious that the data after recovery can be directly accessed and used since there is operating system booting up and servicing for the host 100. However, it is not necessarily the original host 100 that can fulfill the recovery, another host 101 can also do the work, and the host 101 can even be a virtual machine. While the object storage is located in the cloud, the cloud service provider can easily provide the virtual machine in the architecture and accomplish the data recovery in a timely, convenient, and cost-efficient manner.

This is an achievement that no other archiving or backup systems can meet. A notable advantage that the system 10 can provides is to support any changes associated with system booting, as well to support the cloud-based structure for backup/recovery by utilizing its storage and virtual machine. It should be noticed that the archiving data may be in its original form or de-duplicated, compressed, or encrypted before been stored to the object storage 230 to save space or for security concerns. Some objects in the archiving data may be related. Relationship between objects is stored in the pointer and the metadata. Most important of all, the DTVM 220 is a standalone server in this embodiment. In practice, it can be a software installed in the original disk storage 210 or the host (application server) 100 linked to the original disk storage 210. It is not limited by the present invention.

In one example of the present embodiment, the DTVM 220 may recover the original disk storage 210 the same as it was if there is no change in the operating system. The space where the archiving data restored may be a physical space. It can also be a space in a virtual disk. The physical space and the virtual space may not have the same size. In another example, the archiving data only contains files. By the metadata, it is to know that the original operating system and file system for the original disk storage 210 are Windows XP and NTFS. The DTVM 220 can add the related files of Windows XP and NTFS format into the metadata, pointer, and/or object so that the original disk storage 210 can become a hard drive with booting function. On the other hand, if there are other supporting data and operating system image files in the object storage 230, these data and files can be one kind of initiating information and added into the objects of the archiving data for restoring. If the original disk storage 210 is already a systematic hard drive and the host 100 needs to install some device drivers for its hardware, or the host 100 is a virtual machine, the DTVM 220 can add those drivers for hardware or booting drivers for the virtual machine into the objects of the archiving. Booting function still works.

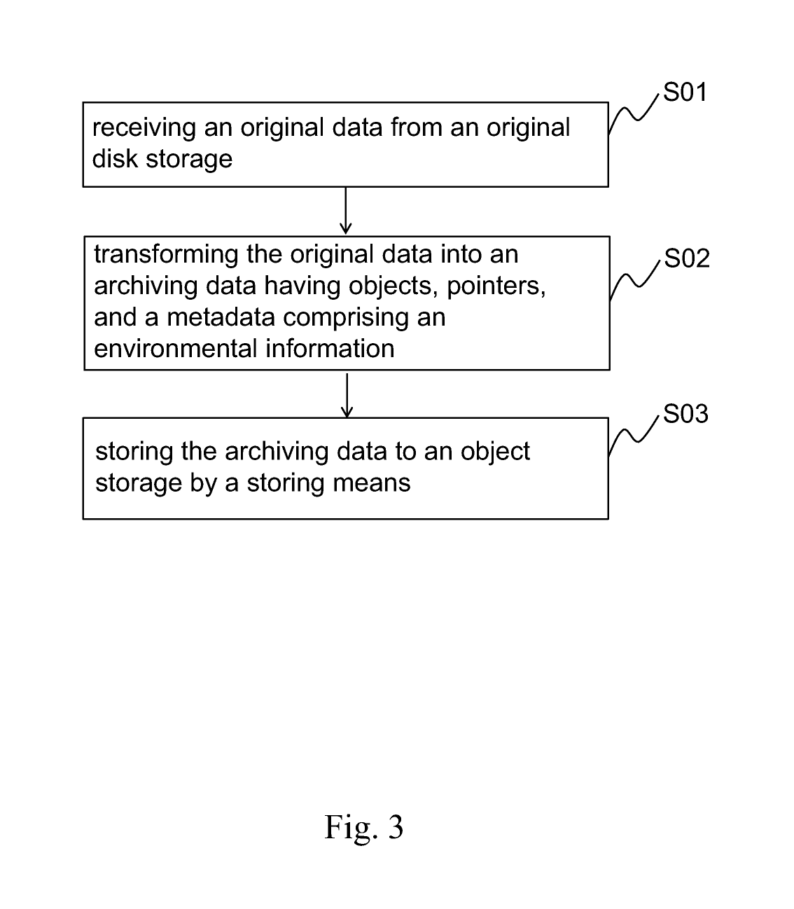

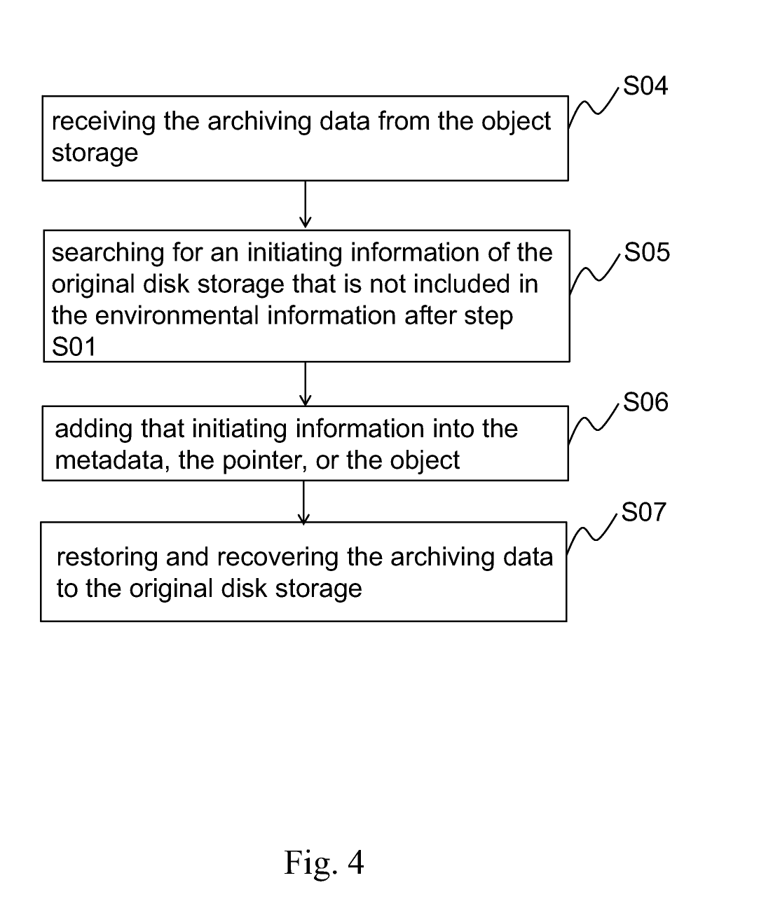

In summary, if the system 10 works for data archiving or backup, the processes are as below. Please refer to FIG. 3. The DTVM 220 receives an original data from the original disk storage 210 (S01). Then, the DTVM 220 transforms the original data into the archiving data which has objects, pointers, and a metadata comprising an environmental information (S02). Each object is referred to by a pointer. Finally, The DTVM 220 stores the archiving data to the object storage 230 by the storing means (S03). The archiving data may be in its original form or de-duplicated, compressed, or encrypted before step S03. If the system 10 works for data restoring or recovery, the processes are as below. Please refer to FIG. 4. The DTVM 220 receives the archiving data from the object storage 230 (S04). The DTVM 220 searches for an initiating information of the original disk storage 210 that is not included in the environmental information after step S01 (S05). The DTVM 220 adds the initiating information into the metadata, the pointer, or the object (S06). Finally, the DTVM 220 restores the archiving data to the original disk storage 210 (S07).

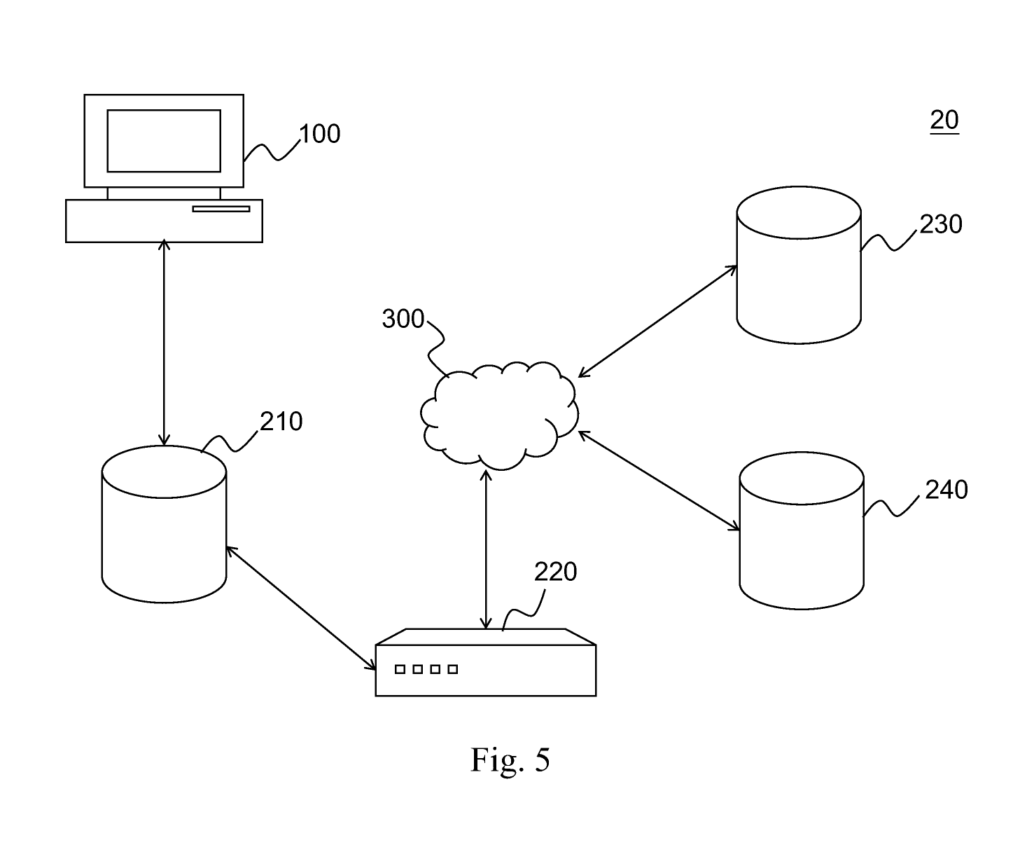

FIG. 5 is another schematic diagram of a system 20 for data transformation for cloud-based archiving and backup according to the present invention. By applying the same elements in the previous embodiment where the element has the same symbol functions the same, the present embodiment further includes a target disk storage 240. The stored archiving data will be restored to the target disk storage 240. The target disk storage 240 stores data. Actually, the DTVM 220 can optionally restore the archiving data to the target disk storage 240 or the original disk storage 210. Note that during the restoring and recovery phase, the data can be restored to the target disk storage 240 other than original disk storage 210. It is highly suggested to restoring to the cloud storage provided by the cloud service provider. Pairing up with the virtual machine provided by the cloud service provider mentioned above, the restore and recovery can be accomplished in the cloud.

According to the present invention, the processes for restoring and recovering the archiving data to the target disk storage 240 are similar to original disk storage 210. It is just different in the steps S05 and S07. The amended step S05′ should be the DTVM 220 searches for an initiating information of the target disk storage 240 that is not included in the environmental information. The amended step S07′ should be the DTVM 220 restores the archiving data to the target disk storage 240. Therefore, the supplemented initiating information in the objects, pointers, and metadata are able to make the target disk storage 240 functions as the original disk storage 210.

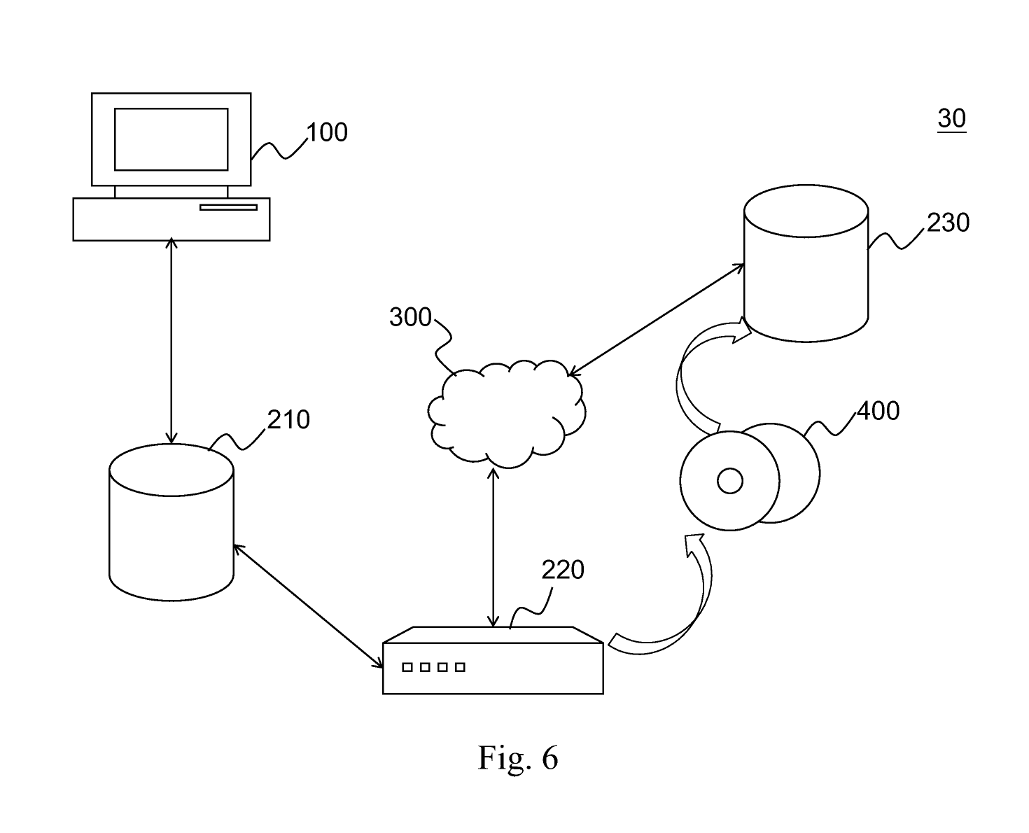

Please refer to FIG. 6. FIG. 6 is still another schematic diagram of a system 30 for data transformation for cloud-based archiving and backup according to the present invention. The system 30 is the same as the system 10. The only difference FIG. 6 presents is that the archiving data does not store to the object storage 230 via internet 300 (restoring processes utilize internet 300). Instead, the archiving data is exported to a Digital Video Disk (DVD) 400. The DVD 400 is dispatched to where the object storage 230 is, e.g. the office of the administrator of the object storage 230. The administrator imports the content of the DVD 400 to the object storage 230. Of course, a flash memory drive can be another carrier as the DVD 400 does.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for data transformation for cloud-based archiving and backup, comprising the steps of:
A. receiving an original data from an original disk storage;
B. transforming the original data into an archiving data having objects, pointers, and a metadata comprising an environmental information, wherein each object is referred to by a pointer; and
C. storing the archiving data to an object storage by a storing means.

2. The method according to claim 1, wherein the environmental information comprises working environment of the original disk storage, system booting of a host by which the original disk storage is accessed, and hardware configuration of the host.

3. The method according to claim 1, wherein the object is a disk block data or a file.

4. The method according to claim 1, wherein the archiving data is in its original form or de-duplicated, compressed, or encrypted before step C.

5. The method according to claim 1, wherein a relationship between objects is stored in the pointer and the metadata.

6. The method according to claim 1, wherein the storing means stores the archiving data integrally or by groups of objects.

7. The method according to claim 1, wherein the storing means is uploading via internet, uploading via Local Area Network (LAN), uploading via Wild Area Network (WAN), or exporting to a Digital Video Disk (DVD), dispatching the DVD to where the object storage is, and importing the content of the DVD to the object storage.

8. A method for recovering the archiving data in claim 1, comprising the steps of:
D. receiving the archiving data from the object storage;
E. searching for an initiating information of the original disk storage that is not included in the environmental information after step A or an initiating information of a target disk storage that is not included in the environmental information;
F. adding that initiating information into the metadata, the pointer, or the object; and
G. restoring and recovering the archiving data to the original disk storage or the target disk storage.

9. The method according to claim 8, wherein the initiating information comprises working environment of the original disk storage, system booting of the host by which the original disk storage is accessed, and hardware configuration of the host.

10. A system for data transformation for cloud-based archiving and backup, comprising:
an original disk storage for storing data;
an object storage for storing data in form of an object with an associated metadata and a unique identifier; and
a Data Transformation and Virtualization Module (DTVM), for receiving an original data from an original disk storage, transforming the original data into an archiving data having objects, pointers, and a metadata comprising an environmental information, and storing the archiving data to the object storage by a storing means,
wherein each object is referred to by a pointer.

11. The system according to claim 10, wherein the DTVM further receives the archiving data from the object storage, searches for an initiating information of the original disk storage that is not included in the environmental information after the original data has been sent from the original disk storage or an initiating information of a target disk storage that is not included in the environmental information, adds that initiating information into the metadata, the pointer, or the object, and restores the archiving data to the original disk storage or the target disk storage.

12. The system according to claim 11, wherein the target disk storage stores data and the DTVM optionally restores the archiving data to the target disk storage.

13. The system according to claim 10, wherein the environmental information comprises working environment of the original disk storage, system booting of a host by which the original disk storage is accessed, and hardware configuration of the host.

14. The system according to claim 10, wherein the object is a disk block data or a file.

15. The system according to claim 10, wherein the archiving data is in its original form or de-duplicated, compressed, or encrypted before been stored to the object storage.

16. The system according to claim 10, wherein a relationship between objects is stored in the pointer and the metadata.

17. The system according to claim 10, wherein the storing means stores the archiving data integrally or by groups of objects.

18. The system according to claim 10, wherein the storing means is uploading via internet, uploading via Local Area Network (LAN), uploading via Wild Area Network (WAN), or exporting to a Digital Video Disk (DVD), dispatching the DVD to where the object storage is, and importing the content of the DVD to the object storage.

19. The system according to claim 10, wherein the DTVM is a standalone server, or a software installed in the original disk storage or an application server linked to the original disk storage.
